(19) United States
(12) Patent Application Publication
(10) Pub. No.: US 2017/0289160 A1
(43) Pub. Date: Oct. 5, 2017

(54) CONTROL SYSTEM, CONTROL METHOD, AND NON-TRANSITORY COMPUTER-READABLE STORAGE MEDIUM

(71) Applicant: FUJITSU LIMITED, Kawasaki-shi (JP)

(72) Inventors: Minehiko Iida, Fuji (JP); Manabu Nakashima, Mishima (JP); Shinya Masaki, Shizuoka (JP); Yuhei Shibukawa, Kawasaki (JP); Satoshi Ohta, Kitanagoya (JP); Kenichi Yamashita, Yokohama (JP)

(73) Assignee: FUJITSU LIMITED, Kawasaki-shi (JP)

(21) Appl. No.: 15/457,042

(22) Filed: Mar. 13, 2017

(30) Foreign Application Priority Data
Mar. 30, 2016 (JP) 2016-069207

(51) Int. Cl. H04L 29/06

(52) U.S. Cl. CPC H04L 63/10; H04L 63/0281; H04L 63/0869

(57) ABSTRACT

A control system includes a communication control device including a memory, and a processor coupled to the memory and configured to execute a determination process that includes, when an operation request is received via a specific destination server, determining whether the operation request is a management operation or an application operation based on header information included in the operation request, execute a transfer process that includes, if the operation request is the application operation, transferring the operation request related to the application operation to a server running the application, and execute a blocking process that includes, if the operation request is the management operation, blocking the operation request related to the management operation.

### CROSS-REFERENCE TO RELATED APPLICATION

This application is based upon and claims the benefit of priority of the prior Japanese Patent Application No. 2016-069207, filed on Mar. 30, 2016, the entire contents of which are incorporated herein by reference.

### FIELD

The embodiments discussed herein are related to a control system, a control method, and a non-transitory computer-readable storage medium.

### BACKGROUND

In recent years, services using cloud computing (hereinafter described as a cloud service) are widespread among general users. Further, cases where business systems for use in company activities are moved into a cloud computing environment are on the rise. With moving business systems into a cloud computing environment, it becomes possible to handle services (business systems) published on the Web in the same manner as applications installed on a client.

When an administrator accesses a business system that is operating on the premises, the administrator accesses an information processing apparatus on which the business system is installed by using a remote login, or the like. It is possible for the administrator to access the business system by using a remote login and to manage the business system.

On the other hand, when an administrator attempts to access a business system that is operating in a cloud environment, the administrator accesses the business system via the Internet. When the administrator accesses the business system via the Internet and performs a management operation, there arises an increasing possibility that information regarding the management operation and important information (authentication information, or the like) related to the business system might be exposed. Further, since it is possible to perform a management operation via the Internet, there arises a risk of masquerading, or the like.

Thus, the operations performed by an administrator are limited to the communication within an intranet and management operations (communication) via the Internet are blocked so that measures are taken against information exposure and masquerading.

The following technique is known. A data communication path and a control communication path are separated, the control communication path is provided with a multiplex circuit that multiplexes control packets, and shortest job priority control is performed. With this technique, it is possible to reduce the average round-trip communication time and hardware costs.

Also, a device is known that distributes the total traffic to a plurality of communication paths and enables high bandwidth communication without the same packet being received twice and wasting of wireless resources.

Further, a technique is known that enables transmission of packets via a communication path that is best suited for transmitting the packets, and that enables allocation of packets to separate communication paths to make it possible to transmit packets with high efficiency and high quality. This technique also avoids simultaneous transmission of the same packets to one reception device so as to reduce wasteful packet communication.

As examples of the related art, Japanese Laid-open Patent Publication Nos. 2011-135433, 2004-96247, and 2005-123993 are known.

### SUMMARY

According to an aspect of the invention, a control system includes: a destination server to be a destination of an operation request via the Internet; and a communication control device including a memory, and a processor coupled to the memory and configured to execute a determination process that includes, when the operation request is received via a specific destination server, determining whether the operation request is a management operation or an application operation based on header information included in the operation request, execute a transfer process that includes, if the operation request is the application operation, transferring the operation request related to the application operation to a server running the application, and execute a blocking process that includes, if the operation request is the management operation, blocking the operation request related to the management operation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an example of processing of a reception control system related to management operations;

FIG. 2 is a diagram for explaining an example of processing of a reception control system related to application operations;

FIG. 3 is a diagram for explaining an example of processing of a reception control system related to application communication;

FIG. 4 is a diagram for explaining an example of a block configuration of a WAF;

FIG. 5 is a diagram for explaining an example (1 of 3) of a request that is blocked by the WAF;

FIG. 6 is a diagram for explaining an example (2 of 3) of a request that is blocked by the WAF;

FIG. 7 is a diagram for explaining an example (3 of 3) of a request that is blocked by the WAF;

FIG. 8 is a diagram for explaining an example of a hardware configuration of the WAF; and

FIG. 9 is a flowchart for explaining an example of processing of the reception control system according to the present disclosure.

### DESCRIPTION OF EMBODIMENTS

The management operations in a business system that is running in a cloud environment are performed via the Internet. More specifically, the management operations are performed using a Representation State Transfer (REST)-ful application programming interface (API), which provides a mechanism for transmitting a request to a specified Uniform Resource Locator (URL) and receiving the response. In order to specify a URL, a protocol, such as Hypertext Transfer Protocol (HTTP) or Hypertext Transfer Protocol Secure (HTTPS), is used.

Further, the operations (start, file allocation, stop, and the like) related to an application that are executed by a user are performed by the user using the RESTful API.

Here, when the management operations performed by an administrator are limited to the communication within an intranet, and the management operations (communication) via the Internet are blocked, it is desirable that the blocking be performed by using a firewall. It is possible for a firewall to control allowing or blocking communication by specifying an Internet protocol (IP) address and a port number. However, the management operations and the operations related to applications are both communication using HTTP or HTTPS, and thus it is not possible for the related-art firewall to distinguish the management operations from the operations related to applications.

As one aspect of the present embodiment, provided are solutions for being able to distinguish management operations by an administrator from application operations performed by a user via a firewall, and block the management operations performed by an administrator.

In the present disclosure, communications from a user and an administrator are distinguished based on the HTTP protocol characteristics, and thereby an administrator who transmits and receives important information in the system is suppressed from performing the operations (communication) via the Internet. Accordingly, a network having secure operation is realized.

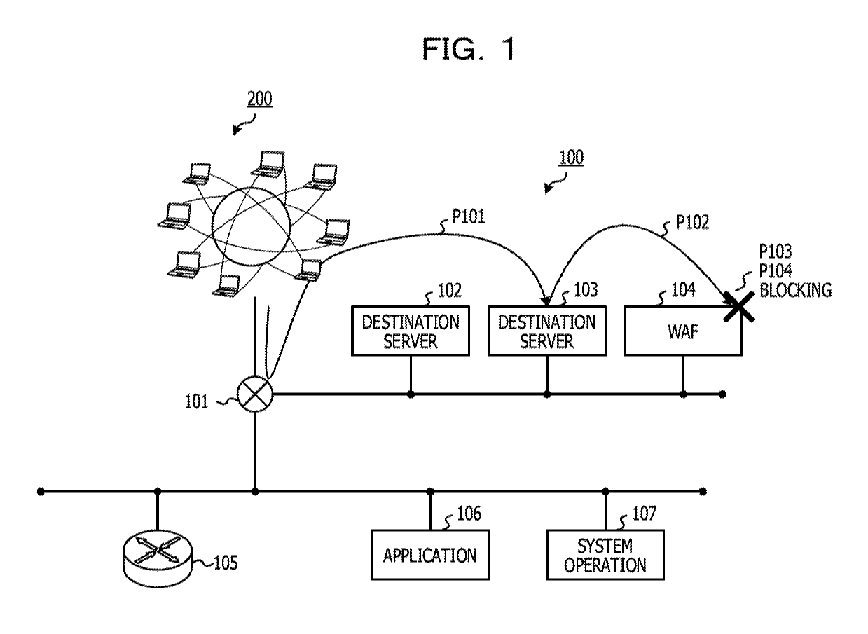

FIG. 1 is a diagram for explaining an example of processing of a reception control system related to management operation. A reception control system 100 is a system that receives various operations and access events when a user and an administrator use a business system and applications via the Internet 200. The reception control system 100 includes a router 101, a destination server 102, a destination server 103, a Web Application Firewall (WAF) 104, a reverse proxy server 105, a Web server 106, and a Web server 107.

The router 101 is a router that is installed on the boundary between the reception control system 100 and an external network (the Internet 200). The router 101 is provided with a firewall, for example, relays and monitors internal and external communications, and protects the internal network from external attacks. Communication from an external network is transmitted through the router 101 and is transmitted to the destination server 102 or the destination server 103. Accordingly, in the reception control system 100, the communication from the external network is not transmitted directly to the reverse proxy server 105, the Web server 106, and the Web server 107.

The destination server 102 is a server to be a destination when a user establishes communication (access) related to applications via the Internet 200. The Web server 106 is a server that runs applications. Here, in a cloud system, the Web server 106 is not directly exposed to users. Communication (access) related to applications from a user goes through the destination server 102 and is then transferred to the Web server 106.

The destination server 103 is a server to be a destination when a user performs an application operation (start, file allocation, stop, or the like) or an administrator performs a management operation via the Internet 200. The WAF 104 is an example of a component (a device, software, or a system) that monitors the destination server 103 and blocks the management operation when the communication via the Internet 200 is a management operation. The WAF 104 is capable of operating as a communication control device, for example. The Web server 107 is an example of a server that runs a business system. Here, in a cloud system, the Web server 107 is not directly exposed to users. An application operation once goes to the destination server 103 and then is transferred to the Web server 107.

The reverse proxy server 105 transfers communication that has been transmitted through the destination server 102 or the destination server 103 to the Web server 106 or the Web server 107 based on a Fully Qualified Domain Name (FQDN).

A description will be given of the processing in sequence when an access (request) related to a management operation is received by the reception control system 100. An administrator makes an access (request) related to management operation via the Internet 200 using the HTTP or HTTPS protocol (RESTful API). For example, a management operation request is sent via the Internet 200 to the destination server 103 (packet processing P101). The management operation request sent to the destination server 103 is sent to the WAF 104 (packet processing P102). The WAF 104 determines whether the request is an application operation performed by a user or a management operation performed by an administrator (packet processing P103). Since the request is a management operation, the WAF 104 blocks the communication (packet processing P104).

In this regard, the WAF 104 has a definition file in which the characteristics of management operation requests in HTTP are described. The WAF 104 identifies a management operation based on the characteristics recorded in the definition file and blocks the communication related to the management operation. The characteristics are stored in the header information included in the request and, for example are the characteristics, such as an FQDN, a path (specific character string), the existence of an HTTP request header, an HTTP method, or the like.

In this manner, it is possible for the WAF 104 to distinguish a management operation performed by an administrator from an application operation performed by a user based on the information included in a request, and to block the management operation performed by the administrator.

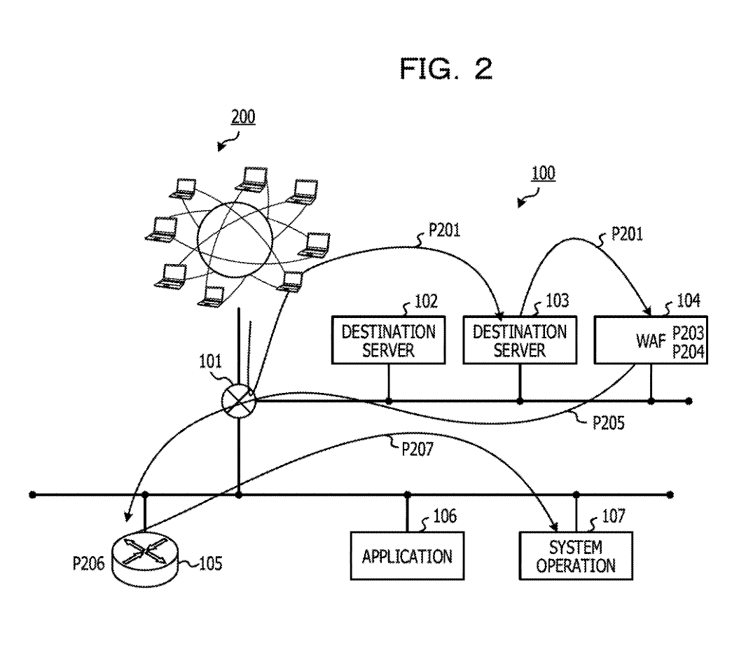

FIG. 2 is a diagram for explaining an example of processing of a reception control system related to application operations. The same part in the reception control system 100 in FIG. 2 as that in the reception control system 100 in FIG. 1 is given the same reference number.

A description will be given of the processing in sequence when communication related to application operations (start, file allocation, stop, and the like) is received by the reception control system 100. A user makes an access (request) related to an application operation via the Internet 200 using HTTP or HTTPS protocol (RESTful API). Specifically, a request related to an application operation is sent from the Internet 200 to the destination server 103 (packet processing P201). The request of the application operation that has been sent to the destination server 103 is sent to the WAF 104 (packet processing P202). The WAF 104 determines whether the request is an application operation performed by a user or a management operation performed by an administrator (packet processing P203). The WAF 104 identifies that the communication at this time is an application operation based on the definition file (packet processing P204). The WAF 104 transmits the request related to the application operation to the reverse proxy server 105 (packet processing P205). The reverse proxy server 105 identifies the transmission destination of the request related to the application operation as the Web server 107 based on the FDQN (packet processing P206). The reverse proxy server 105 transfers the request related to the application operation to the Web server 107 (packet processing P207).

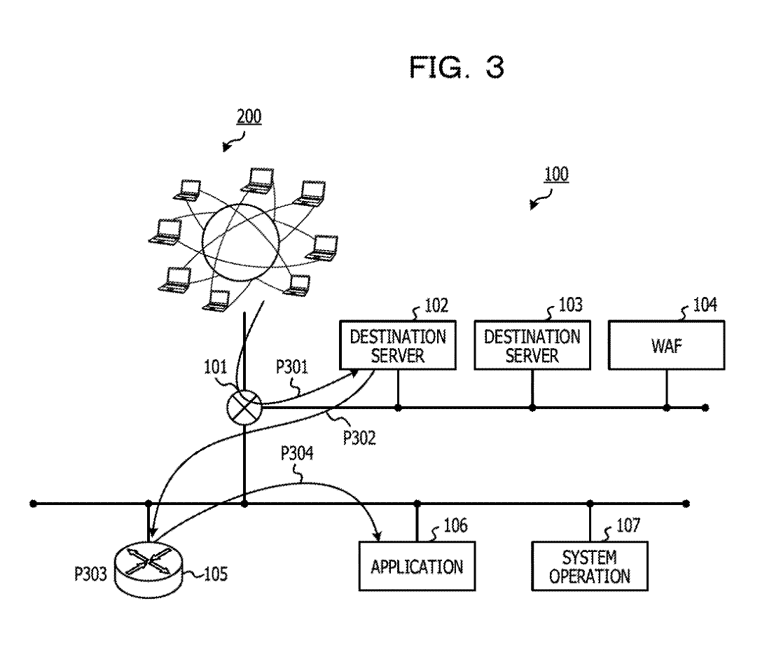

FIG. 3 is a diagram for explaining an example of processing of the reception control system related to application communication. The same part in the reception control system 100 in FIG. 3 as that in the reception control system 100 in FIG. 1 is given the same reference number.

A description will be given of the processing in sequence when application communication from a user is received by the reception control system 100. A user performs access (request) related to application communication from the Internet 200 using the HTTP or HTTPS protocol. Specifically, the request related to the application communication is sent from the Internet 200 to the destination server 102 (packet processing P301). The request of the application communication sent to the destination server 102 is not sent to the WAF 104, but is sent to the reverse proxy server 105 (packet processing P302). The reverse proxy server 105 identifies the transmission destination of the request related to the application communication based on the FDQN as the Web server 106 (packet processing P303). The reverse proxy server 105 transfers the request related to the application communication to the Web server 106 (packet processing P304).

In this manner, it is possible for the WAF 104 to distinguish a management operation performed by an administrator from an application operation performed by a user based on the information included in a request, and to block a management operation performed by an administrator. On the other hand, the requests related to application communication are caused not to be sent to the WAF 104 so that it is possible to minimize the performance impact on the system.

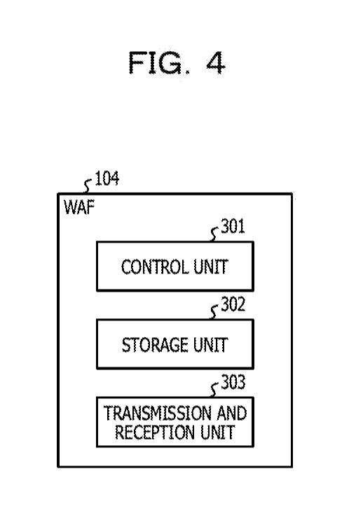

FIG. 4 is a diagram for explaining an example of a block configuration of a WAF. The WAF 104 includes a control unit 301, a storage unit 302, and a transmission and reception unit 303. The transmission and reception unit 303 receives a request sent to the destination server 103 (specific server). The control unit 301 determines whether the request that has been sent to the destination server 103 (specific server) is an application operation performed by a user or a management operation performed by an administrator. If the request is a request related to a management operation, the control unit 301 blocks the request and does not transfer the request to the other device. On the other hand, if the request is a request related to an application operation, the transmission and reception unit 303 transfers the request to the reverse proxy server 105.

In this manner, it is possible for the WAF 104 to distinguish a management operation performed by an administrator and an application operation performed by a user based on the information included in the request and to block a management operation performed by an administrator. On the other hand, a request related to application communication is caused not to be sent to the WAF 104 so that it is possible to minimize the performance impact on the system.

The storage unit 302 stores a definition file in which the characteristics of a request related to a management operation in HTTP are described. The characteristics stored in the definition file refer to the header information included in the request and are for example, an FQDN, a path (specific character string), the existence of the HTTP request header, an HTTP method, and the like.

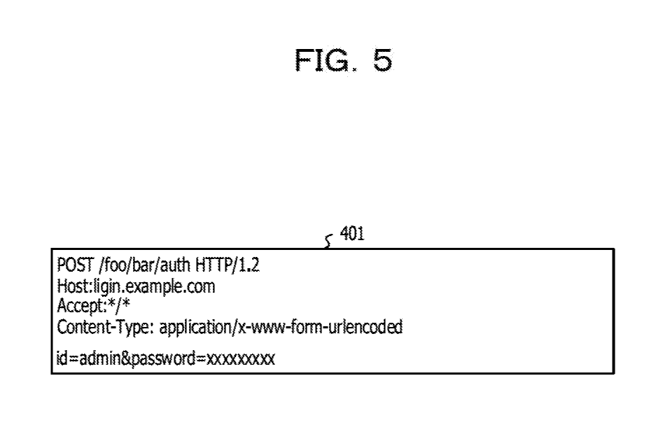

FIG. 5 is a diagram for explaining an example (1 of 3) of a request that is blocked by the WAF. A request 401 is a detailed example of an HTTP request related to a login operation performed by an administrator identifier (ID). The WAF 104 blocks the login operation performed by the administrator ID as a management operation.

In the host header in the request 401, login.example.com is set as the FQDN to be used at the time of an authentication operation. The WAF 104 determines whether or not the request is a management operation depending on whether the FQDN (login.example.com) at the time of the authentication operation is set in the Host header.

A specific character string (/foo/bar/auth) to be specified at the time of the authentication operation is set in the POST method, which is an HTTP method of the request 401. The POST method is a method to be used at the time of transmitting data, such as a name, a value, or the like. The WAF 104 determines whether or not the request is a management operation depending on whether or not a specific character string (for example, a file path used for authentication) to be specified at the time of authentication operation is set in the HTTP method.

An administrator ID (id=admin) is set in the HTTP body of the request 401. The WAF 104 determines whether or not the request is a management operation depending on whether or not an administrator ID is set in the HTTP body.

If the request 401 includes an FQDN at the time of authentication operation in the Host header, a specific character string to be specified at the time of authentication operation in the HTTP method, and an administrator ID in the HTTP body, the WAF 104 determines that the request 401 is a request related to a management operation and blocks the request. In this regard, an FQDN, a specific character string (file path), an administrator ID, and the like constitute an example, and another address, an ID, and the like may be used.

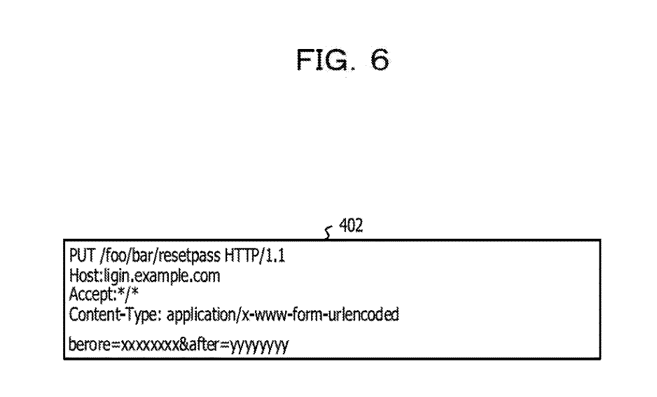

FIG. 6 is a diagram for explaining an example (2 of 3) of a request that is blocked by the WAF. A request 402 is a detailed example of an HTTP request related to a password reset performed by an administrator. The WAF 104 blocks a password reset operation as a management operation.

As the FQDN to be used at the time of the password reset operation, login.example.com is set in the Host header in the request 402. The WAF 104 determines whether or not the request is a management operation depending on whether the FQDN (login.example.com) at the time of the password reset operation is set in the Host header.

The PUT method is set in the HTTP method in the request 402. The PUT method is a method to be used when a specified file on a server is replaced. The WAF 104 determines whether or not the request is a management operation depending on whether or not the PUT method is set in the HTTP method.

A specific character string (/foo/bar/resetpass) to be specified at the time of password reset operation is set in PUT, which is an HTTP method, in the request 402. The WAF 104 determine whether or not the request is a management operation depending on whether or not a specific character string (for example, a file path to be used for the password reset operation) to be specified at the time of password reset operation is set in the HTTP method.

If the request 402 includes an FQDN to be used at the time of password reset operation in the HTTP header, the PUT method in the HTTP method, and a specific character string to be specified at the time of password reset operation in the HTTP method, the WAF 104 determines that the request 402 is a request related to a management operation, and blocks the request. In this regard, the FQDN, the specific character string (file path), and the like are one example, and another address, and the like may be used.

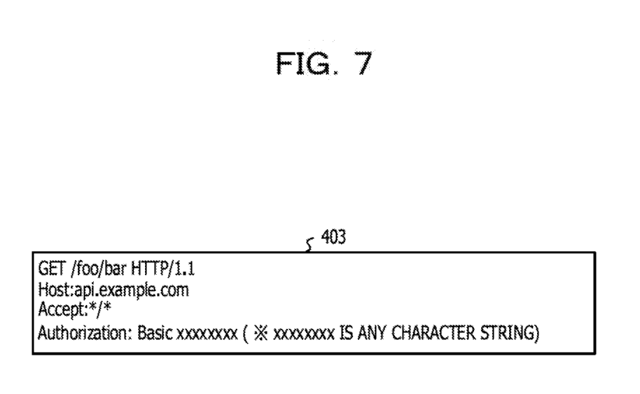

FIG. 7 is a diagram for explaining an example (3 of 3) of a request that is blocked by the WAF. The request 403 is a detailed example of an HTTP request related to an operation that calls an internal API that is not published to users. The WAF 104 blocks the internal API operation as a management operation.

In the Host header in the request 403, api.example.com is set as an FQDN to be used at the time of internal API operation. The WAF 104 determines whether or not the request is a management operation depending on whether or not the FQDN (api.example.com) at the time of internal API operation is set in the Host header.

The request 403 includes a request (Authorization: Basic xxxx) for the BASIC authentication. The string xxxx represents any character string. The WAF 104 determines whether or not the request is a management operation depending on whether or not the request for the BASIC authentication is included.

If the request 403 includes the FQDN to be used at the time of internal API operation and a request for the BASIC authentication in the HTTP header, the WAF 104 determines that the request 403 is a request related to a management operation and blocks the request. In this regard, the FQDN is one example, another address, or the like may be used.

In this manner, it is possible for the WAF 104 to distinguish a management operation performed by an administrator and an application operation performed by a user based on the information included in the request, and to block a management operation performed by an administrator. On the other hand, a request related to application communication is not sent to the WAF 104 so that it is possible to minimize the performance impact on the system.

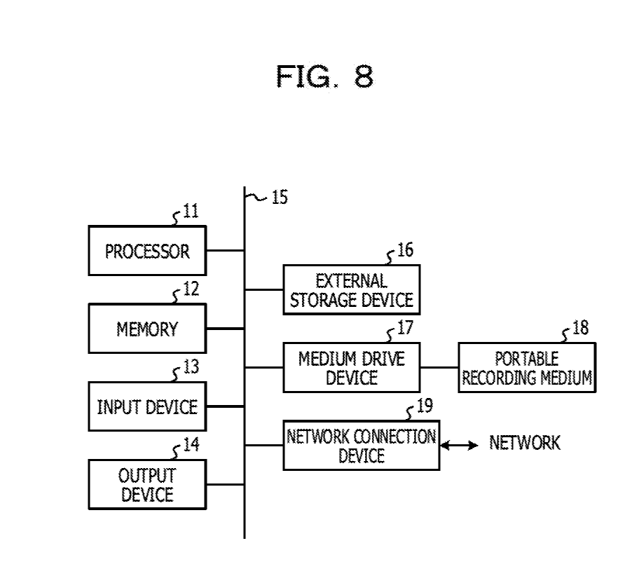

FIG. 8 is a diagram for explaining an example of a hardware configuration of the WAF. The WAF 104 includes a processor 11, a memory 12, a bus 15, an external storage device 16, and a network connection device 19. Further, the WAF 104 may include an input device 13, an output device 14, and a medium drive device 17 as options. The WAF 104 is sometimes achieved by, for example a computer, or the like.

The processor 11 may be any processing circuit that includes a central processing unit (CPU). The processor 11 operates as the control unit 301. In this regard, it is possible for the processor 11 to execute a program stored in the external storage device 16, for example. The memory 12 suitably stores the data obtained by the operation of the processor 11, and the data to be used for the processing by the processor 11. The memory 12 operates as the storage unit 302. The network connection device 19 is used for communication with another device, and operates as the transmission and reception unit 303.

The input device 13 is realized by, for example, a button, a keyboard, a mouse, or the like. The output device 14 is realized by a display, or the like. The bus 15 couples the processor 11, the memory 12, the input device 13, the output device 14, the external storage device 16, the medium drive device 17, and the network connection device 19 so as to enable data transfer among these devices. The external storage device 16 stores programs, data, and the like, and suitably provides the stored information to the processor 11, and the like. The medium drive device 17 is capable of outputting the data in the memory 12 and the external storage device 16 to the portable storage medium 18, and reading the programs, data, and the like from the portable storage medium 18. Here, the portable storage medium 18 may be any portable storage medium including a floppy disk, a magneto-optical (MO) disc, a compact disc recordable (CD-R), and a digital versatile disc recordable (DVD-R).

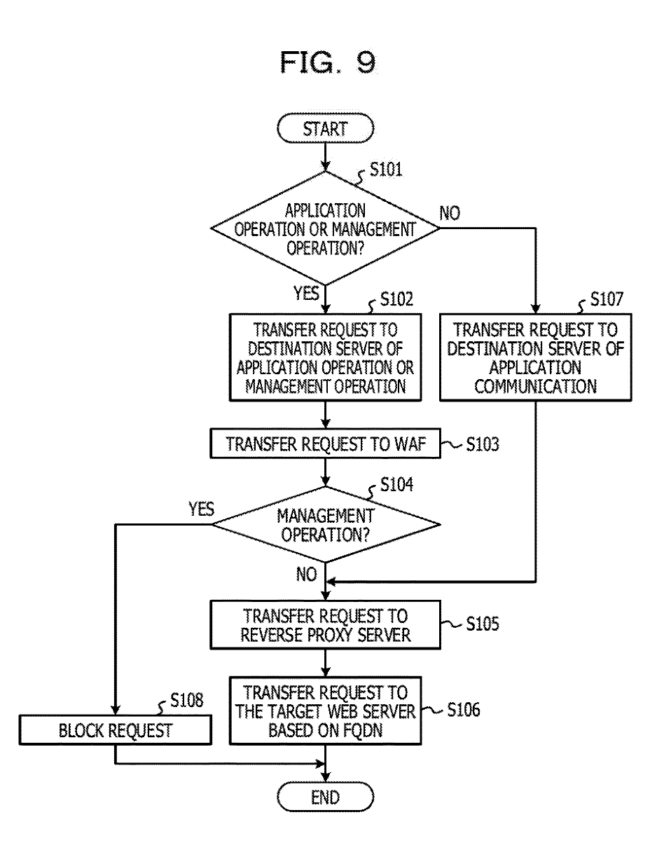

FIG. 9 is a flowchart for explaining an example of the processing of the reception control system according to the present disclosure. The router 101 determines whether or not a request from the Internet 200 is an operation related to an application or a management operation (step S101). If the communication from the Internet 200 is an operation related to an application or a management operation (YES in step S101), the router 101 transfers the request to the destination server 103 (step S102). The destination server 103 transfers the request to the WAF 104 (step S103).

The control unit 301 in the WAF 104 determines whether or not the request is a management operation (step S104). If the request is not a management operation (NO in step S104), the WAF 104 transfers the request to the reverse proxy server 105 (step S105). The reverse proxy server 105 transfers the request to a transmission-target Web server based on the FQDN (step S106). When the processing in step S106 is completed, the reception control system 100 terminates the processing for the request.

If the communication from the Internet 200 is application communication (NO in step S101), the router 101 transfers the request to the destination server 102 (step S107). When the processing in step S107 is completed, the processing in step S105 is executed. However, here the destination server 102 transfers the request to the reverse proxy server 105.

If the request is a management operation (YES in step S104), the WAF 104 blocks the request (step S108). When the processing in step S108 is completed, the reception control system 100 terminates the processing for the request.

In this manner, it is possible for the WAF 104 to distinguish a management operation performed by an administrator and an application operation performed by a user based on the information included in the request, and to block a management operation performed by an administrator. On the other hand, the requests related to application communication are caused not to be sent to the WAF 104 so that it is possible to minimize the performance impact on the system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control system comprising:
a destination server to be a destination of an operation request via the Internet; and
a communication control device including a memory, and a processor coupled to the memory and configured to
execute a determination process that includes, when the operation request is received via a specific destination server, determining whether the operation request is a management operation or an application operation based on header information included in the operation request,
execute a transfer process that includes, if the operation request is the application operation, transferring the operation request related to the application operation to a server running the application, and
execute a blocking process that includes, if the operation request is the management operation, blocking the operation request related to the management operation.

2. The control system according to claim 1,
wherein the determination process includes, if a specific character string to be specified at the time of an authentication operation is set in header information included in the operation request, determining that the operation request is the management operation.

3. The control system according to claim 2,
wherein the specific character string to be specified at the time of the authentication operation is a file path used for authentication.

4. The control system according to claim 3,
wherein the determination process includes if determined based on the header information included in the operation request that the operation request is the management operation, and when administrator identification information to be used for identification of an administrator is set in a body of the operation request, determining that the operation request is a management operation to be blocked by the blocking process.

5. A control method implemented by processor circuitry, the method comprising:
when an operation request is received from the Internet via a specific destination server, determining based on header information included in the operation request whether the operation request is a management operation or an application operation,
if the operation request is the application operation, transferring the operation request related to the application operation to a server running the application, and
if the operation request is the management operation, blocking the operation request related to the management operation.

6. The control method according to claim 5,
wherein the determination process includes, if a specific character string to be specified at the time of an authentication operation is set in header information included in the operation request, determining that the operation request is the management operation.

7. The control method according to claim 6,
wherein the specific character string to be specified at the time of the authentication operation is a file path used for authentication.

8. The control method according to claim 7,
wherein the determination process includes if determined based on the header information included in the operation request that the operation request is the management operation, and when administrator identification information to be used for identification of an administrator is set in a body of the operation request, determining that the operation request is a management operation to be blocked by the blocking process.

9. A non-transitory computer-readable storage medium storing a program that causes a computer to execute a process, the process comprising:
when an operation request is received from the Internet via a specific destination server, determining based on header information included in the operation request whether the operation request is a management operation or an application operation,
if the operation request is the application operation, transferring the operation request related to the application operation to a server running the application, and
if the operation request is the management operation, blocking the operation request related to the management operation.

10. The non-transitory computer-readable storage medium according to claim 9,
wherein the determination process includes, if a specific character string to be specified at the time of an authentication operation is set in header information included in the operation request, determining that the operation request is the management operation.

11. The non-transitory computer-readable storage medium according to claim 10,
wherein the specific character string to be specified at the time of the authentication operation is a file path used for authentication.

12. The non-transitory computer-readable storage medium according to claim 11,
wherein the determination process includes if determined based on the header information included in the operation request that the operation request is the management operation, and when administrator identification information to be used for identification of an administrator is set in a body of the operation request, determining that the operation request is a management operation to be blocked by the blocking process.
